(19) United States
(12) Patent Application Publication
(10) Pub. No.: US 2024/0044349 A1
(43) Pub. Date: Feb. 8, 2024

(54) DEVICE FOR COMPENSATING FOR TOLERANCES

(71) Applicant: WITTE Automotive GmbH, Velbert (DE)

(72) Inventors: Jan Christian BENTE, Sprockhövel (DE); Glen LEE, Köln (DE); Thomas GLAS, Farmington Hills, MI (US); Ismail ULU, Wuppertal (DE)

(21) Appl. No.: 18/364,500

(22) Filed: Aug. 3, 2023

(30) Foreign Application Priority Data
Aug. 3, 2022 (DE) 10 2022 208 078.5

(51) Int. Cl. F16B 5/02

(52) U.S. Cl. CPC F16B 5/0233; F16B 5/025

(57) ABSTRACT

A device for compensating for tolerances between two components to be connected to one another, where one of the components is formed from a creep-sensitive material, may have a base element and a compensating element which is in threaded engagement with the base element and which can be moved from a starting position into a compensating position by rotation relative to the base element. The base element is designed as a one-piece, hollow cylindrical element with a base portion and a spacer portion. The spacer portion is pre-positioned or fixable on the component made of the creep-sensitive material such that the spacer portion projects into an opening of the component in a state pre-positioned or fixed on one of the components.

### FIELD

The invention relates to a device for compensating for tolerances between two components to be connected to one another.

### BACKGROUND

Such a tolerance compensation device is basically known and is used, for example, in vehicle assembly—in particular, when two components need to be bolted together across a tolerance-affected joint gap. For this purpose, the tolerance compensation device is arranged between the components to be connected, and a screw member for screwing the components, e.g., a screw or threaded bolt, is passed through correspondingly provided openings in the components and through the tolerance compensation device. When screwing the screw element, the compensating element is rotated relative to the base element by means of a driving spring connected between the screw element and the compensating element and is thus moved from its starting position axially to the base element, e.g., it is moved out of the base element until it reaches its compensating position, in which the base element and the compensating element each lie against one of the components and thus bridge the joint gap.

Tolerance compensation systems are known, for example, from DE 10 2018 201 828 A1 and DE 10 2008 026 414 A1.

### SUMMARY

The object of the present invention is to specify a device, improved in relation to the prior art, for compensating for tolerances between two components to be connected to one another.

With regard to the device, the object is achieved according to the invention by the features specified in the claims.

The device according to the invention for compensating for tolerances between two components to be connected to one another comprises at least one base element, a compensating element which is in threaded engagement with the base element and is in particular hollow cylindrical, which element can be moved from an initial position into a compensating position by rotation relative to the base element, wherein the base element is designed as a one-piece, hollow cylindrical component with a base portion and a spacer portion which projects into an opening of the component in a state that is pre-positioned or fixed on one of the components.

An alternative device according to the invention for compensating for tolerances between two components to be connected to one another comprises at least one base element, a compensating element which is in threaded engagement with the base element and is in particular hollow cylindrical, which element can be moved from a starting position into a compensating position by rotation relative to the base element, and a fastening element which is guided through the device and through correspondingly provided openings in the components and can be screwed into a nut element—in particular, a screw element or a threaded bolt for screwing the components—wherein the nut element has a base portion and a spacer portion which projects into an opening of the component in a state pre-positioned or fixed on one of the components.

In particular, the spacer portion of the base element or of the nut element is pre-positioned or fixable on a component made of a creep-sensitive material in such a way that this spacer portion projects into an opening of this component. The two components and/or the device, or at least one or more of these, can be designed as plastic components that are compression-bonded. For this purpose, for example, a connecting element, such as a screw element (referred to as a screw for short), is moved through the device and one of the components and into the other component and tightened, so that the components and the device are pressed together and are connected to one another in a preloaded manner.

At least one of the components is formed from a creep-sensitive material. Both components can also be formed from a creep-sensitive material, and/or the device for compensating for tolerances can be formed from a creep-sensitive material. For example, at least one of the components is formed from a plastic material. Plastic materials can have the property that, when they are subjected to compressive forces over a relatively long time, they are susceptible to a change in shape due to material fatigue, or so-called “creep.” This can lead to a loose connection of the components, which is not desired.

In one possible embodiment, the spacer portion is designed as a compression limiter. The compression limiter is preferably aligned axially. The compression limiter has in particular a length that does not exceed a thickness of the component. The length of the compression limiter is selected, for example, in such a way that this length defines a maximum value for the height of an acting compression force which acts upon this component. Furthermore, the compression limiter can be formed from the less creep-sensitive material and/or from a harder or incompressible material compared to the creep-sensitive material of the component and/or the creep-sensitive material of one of the components of the device. For example, the component and/or the component of the device can be formed from a creep-sensitive plastic material, and the compression limiter can be formed from a sheet-metal material, a thin metal material, and in particular from steel sheet or the like.

In addition, the compression limiter is set up to transfer tension loads acting upon the connecting element or screw element and the components and the device, allowing improved load distribution in the connected state of the components and device.

The advantages achieved with the invention are in particular that an integrated compression limiter is formed by means of such a spacer portion integrated into the base element or the nut element in the manner of an extension of the base portion. Such an integrated spacer portion of the base element or of the nut element additionally enables tolerance compensation without adjustment, and thus automatically. This results in a reduction in the complexity when assembling the device. In particular, the assembly is reduced by a joining process. In addition, the force flow in steel-plastic bonds is improved, and creep of the plastic interface (interface in the component) is prevented. Furthermore, in the embodiment with the longer base element, a compensating path of the device is increased in a simple manner. The device is releasably connectable or connected to the components.

The spacer portion of the base element or of the nut element limits or prevents in particular a so-called loss of preload force, which, in a tolerance compensation device made at least partly of plastic and/or metal or in an assembly interface of the component or components made of plastic, occurs due to material creep or material relaxation—for example, plastic creep or plastic relaxation. In addition, by limiting or preventing the loss of preload force when assembling the device, the device can be reused as often as desired. Furthermore, the spacer portion is designed to automatically clamp the base element in and/or on the component. In addition, the spacer element can be set up to clamp the base element and thus the device against undesired rotation, adjustment, loosening, and/or automatic release during assembly or after wear in and/or on the component. For example, the spacer element can be formed from metal—in particular, steel—or another suitable material—for example, a plastic material, such as a fiber-reinforced plastic material.

The respective spacer portion is designed, for example, as a compression limiter. The respective spacer portion is adjusted in particular in its hardness and dimensions such that it counteracts, and in particular limits or prevents, a loss of preloading force—in particular, as a result of plastic creep or plastic relaxation.

In one possible embodiment, a securing arrangement can be provided which is designed as a transport securing means and which holds the compensating element and the base element in a captive and movement-inhibiting manner or in a movement-resistant manner during transport. The securing arrangement can comprise, for example, a number of securing elements and a number of counter-securing elements which are arranged in a cooperating manner—in particular, in a region between the compensating element and the base element.

In addition, a stop ring can be provided which is arranged between one of the components and the compensating element. The stop ring can be arranged for example in a rotationally-fixed manner on the compensating element. The stop ring can comprise a collar and a stop flange. The collar can be designed in the manner of a sleeve. The collar can project into an opening, and in particular a through-opening, of the compensating element. In the connected state of the components, the stop flange can come into contact both with the one of the components and with the compensating element.

The device can be used in different assemblies and components. The relevant spacer portion of the base element reinforces the device—in particular, the base element—and withstands loads that are exerted, for example, by the fastening element. The relevant spacer portion—in particular, with the function of a compression limiter—reduces a tension relaxation and flow expansion of the base element during installation of the device. By means of the spacer portion, a relaxation behavior or creep behavior of the device—in particular, of the base element—can be substantially reduced or even prevented. The device is in particular a pre-assembled unit. This means that the base element with the integrated spacer portion and the compensating element are pre-assembled to form a unit. The pre-assembled unit of base element and compensating element can be mounted in a customer interface—in particular, in or on one of the components.

### DESCRIPTION OF THE DRAWINGS

Embodiments of the invention are explained in greater detail with reference to the drawings, in which:

FIG. 1 schematically shows, in an exploded view, a device for compensating for tolerances,

FIG. 2 schematically shows, in a sectional view, the device pre-assembled on one of the components,

FIG. 3 shows a schematic side view of the device for compensating for tolerances with a base element with an integrated spacer portion without a compensating element,

FIG. 4 shows a schematic side view of the device for compensating for tolerances with a base element with an integrated spacer portion with a compensating element,

FIG. 5 schematically shows a side view of the base element with base portion and integrated spacer portion,

FIG. 6 schematically shows a side view of the device in a pre-assembly position without a compensating element,

FIG. 7 schematically shows a side view of the device in a pre-assembly position with a compensating element,

FIG. 8 schematically shows in perspectival view a securing arrangement formed as a transport securing means,

FIG. 9 schematically shows a perspectival view of a holding element,

FIG. 10 shows in a schematic view an alternative embodiment of a device for compensating for tolerances,

FIG. 11 schematically shows, in an exploded view, a further alternative embodiment of a device for compensating for tolerances,

FIG. 12 schematically shows a side view of a pre-assembly position of the device according to FIG. 11, and thus the device as a pre-assembly unit,

FIG. 13 schematically shows an exploded view of the device according to FIG. 11 in the pre-assembly position, and one of the components,

FIG. 14 schematically shows a side view of the device according to FIG. 11 with the nut element pre-assembled,

FIG. 15 schematic shows a side view of the device according to FIG. 11 in the final position,

FIG. 16 schematically shows in perspectival view a holding element of the device according to FIG. 11,

FIG. 17 schematically shows in perspectival view a securing arrangement formed as a transport securing means,

FIG. 18 schematically shows in a further perspectival view the securing arrangement designed as a transport securing means,

FIG. 19 schematically shows in perspectival view a base element of the device according to FIG. 11, and

FIG. 20 schematically shows a perspectival view of a nut element of the device according to FIG. 11.

### DETAILED DESCRIPTION

Parts corresponding to one another are provided with the same reference signs in all the figures.

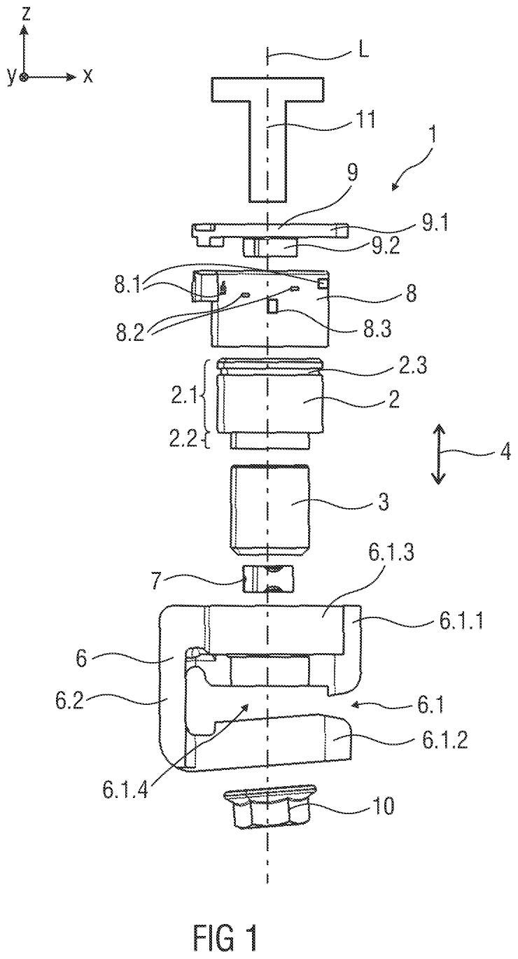

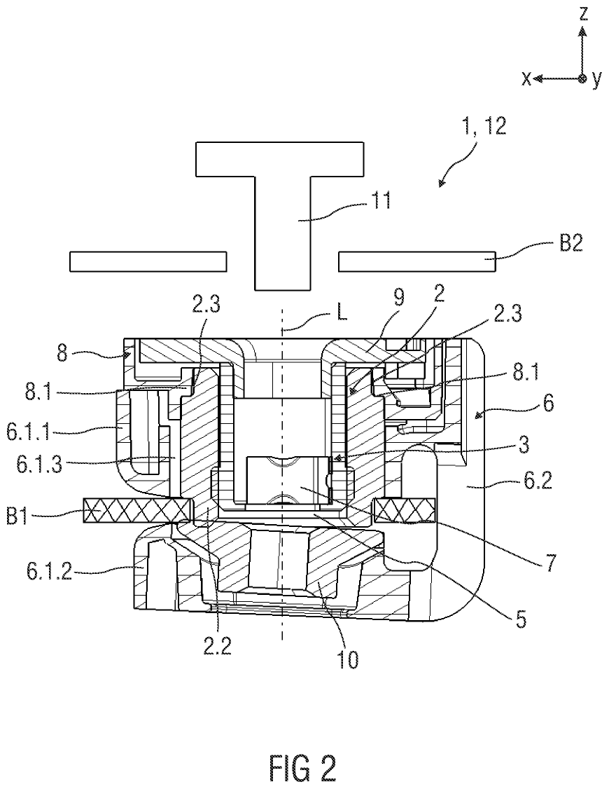

FIG. 1 shows schematically, in an exploded view, an embodiment of a device 1 for compensating for tolerances between two components B1, B2 (shown in FIG. 2) to be connected to one another, in a perspectival view. The device 1 for compensating for tolerances will hereafter be referred to for short as the device 1 or also as the tolerance compensation device. The two components B1, B2 are, for example, vehicle parts, and in particular trim components, vehicle doors, component housings, or the like. At least one of the components B1, B2 can be formed from a creep-sensitive material, and in particular a plastic material.

FIG. 2 schematically shows, in a sectional view, the device 1 pre-assembled on one of the components B1.

The device 1 has at least one base element 2 and a compensating element 3. The base element 2 and the compensating element 3 are designed as hollow cylindrical elements. The base element 2 is designed as a one-piece, hollow cylindrical element and comprises a base portion 2.1 and a spacer portion 2.2.

The compensating element 3 is in threaded engagement with the base element 2. For example, the base element 2 has an internal thread (not shown in more detail), and the compensating element 3 has a corresponding external thread (not shown in more detail). To compensate for tolerances between the two components B1 and B2, the compensating element 3 can be moved from a starting position into a compensating position—in particular, axially along a longitudinal center axis L according to arrow 4—by rotation relative to the base element 2. By rotation, the compensating element 3 can be moved along the longitudinal central axis L relative to the base element 2, i.e., out of the hollow space of the base element 2 or screwed into it.

The spacer portion 2.2 of the base element 2 is designed such that it projects into an opening 5 of the component B1 (shown in FIG. 2) in a state pre-positioned or fixed on one of the components B1. In particular, the spacer portion 2.2 projects into that component B1 that is formed from the creep-sensitive material.

To achieve automatic tolerance compensation without adjustment, the base element 2 comprises the spacer portion 2.2 pointing away from the device 1. The one-piece base element 2 is, for example, made of metal. The integrated spacer portion 2.2 limits or prevents a so-called loss of preload force in the inserted state on the first component B1 automatically, without additional manual adjustment.

The spacer portion 2.2 is designed as a compression limiter for this purpose. The spacer portion 2.2 designed as a compression limiter is oriented axially.

An integrated compression limiter is formed by means of the spacer portion 2.2 integrated into the base element 2 in the manner of an extension of the base portion 2.1. Such an integrated spacer portion 2.2 of the base element 2 additionally enables tolerance compensation without adjustment, and thus automatically. This results in a reduction in the complexity when assembling the device 1. The base element 2 is in particular made of a metal, such as steel or a similar material. The components B1, B2 are in particular made of plastic or a similar material. By means of the integrated spacer portion 2.2 of the base element 2, a force flow in steel-plastic bonds is improved, and creep of the plastic interface—in particular, of an interface in component B1—is counteracted. Furthermore, by means of such a longer base element 2, a compensation path of the device 1 according to arrow 4 is enlarged in a simple manner.

The spacer portion 2.2 designed as a compression limiter has in particular a length that does not exceed a thickness of the creep-sensitive component B1. The length of the compression limiter is selected, for example, in such a way that this length defines a maximum value for the height of an acting compression force which acts upon this component B1. Furthermore, the compression limiter can be formed from the less creep-sensitive material and/or from a harder or incompressible material compared to the creep-sensitive material of the component B1 and/or the creep-sensitive material of one of the components of the device 1. For example, the component B1 and/or the component of the device 1 can be formed from a creep-sensitive plastic material, and the compression limiter can be formed from a sheet-metal material, a thin metal material, and in particular from steel sheet or the like.

In addition, the compression limiter is set up to transfer tension loads acting upon a connecting element, e.g., a screw element 11, and the components B1, B2 and the device 1, so that an improved load distribution in the connected state of components B1, B2 and device 1 is enabled.

The device 1 further comprises a holding element 6, and in particular a holding ring. The holding element 6 can be designed as a holding clip. The holding element 6 can have a C-shape or a J-shape in section, or can be formed as a hollow cylinder. The holding element 6 is used to hold the base element 2 and the compensating element 3 and for fastening—in particular, in the manner of a clamp or clip—to one of the components B1 (shown in FIG. 2).

The holding element 6 can be formed from a plastic material. The base element 2 is held rotationally fixed in the holding element 6. In the present exemplary embodiment, the base element 2 is held indirectly, and in particular indirectly pressed or clamped, in the holding element 6, for example. For example, the holding element 6 has a holding portion 6.1 which extends substantially at right angles to the axial direction, and in particular the longitudinal axis L. The holding portion 6.1 is designed as a clamping portion or latching portion. The holding portion 6.1 comprises, for example, two holding legs 6.1.1 and 6.1.2 arranged at an axial distance from one another. The two holding legs 6.1.1, 6.1.2 can be connected to one another via a web 6.2.

The first holding leg 6.1.1 has a hollow cylindrical receptacle 6.1.3, into which the base element 2 and the compensating element 3 can be arranged. In the assembled state of the device 1, one of the components B1 can be arranged and fixed in the free space 6.1.4 of the holding section 6.1, formed between the two holding legs 6.1.1 and 6.1.2, with a positive or non-positive fit, and in particular fixed in clamping fashion (shown in FIG. 2). The free space 6.1.4 corresponds in particular to a thickness of the component B1.

In an inner cavity of the compensating element 3, there is arranged a driving element 7, designed for example as a driving spring and formed for example from spring steel. The driving element 7 is supported on the jacket surface of the cavity of the compensating element 3 (as shown in FIG. 2). The driving element 7 is in frictional engagement with a screw element 11 guided through the device 1, i.e., through the cavities of the base element 2 and driving element 7, in order to transmit a torque exerted by the screw element 11 to the compensating element 3.

In addition, the device 1 can optionally be a securing arrangement 8, and optionally a stop ring 9. The securing arrangement 8 is for example designed as a transport securing means that holds the compensating element 3 and the base element 2 in a captive and movement-inhibiting manner or in a movement-resistant manner to one another during transport.

In addition, the stop ring 9 can be provided, which is arranged between one of the components B1, B2 and the securing arrangement 8 and/or the compensating element 3.

The stop ring 9 can be designed separately and be arranged in a rotationally-fixed manner on the compensating element 3 or can be formed integrated with it. The stop ring 9 can comprise a collar 9.2 and a stop flange 9.1. The collar 9.2 can project into the opening 5, and in particular a through-opening, of the compensating element 3. In the connected state of the components B1, B2, the stop flange 9.1 can come into contact both with the one of the components B2 and with the compensating element 3 and/or the securing arrangement 8.

Instead of the separate stop ring 9, this can be designed as an integrated flange on the compensating element 3. The stop ring 9 comprises an annular stop flange 9.1 which, in the assembled state of the device 1 and with compensation of tolerances, comes into contact with the component B2. A circumferential collar 9.2 is used for the reception of and rotationally-fixed connection to the compensating element 3.

The securing arrangement 8 forms in particular a transport securing means for the device 1 in order to prevent unintentional movement of the compensating element 3 relative to the base element 2 during transport of the device.

The securing arrangement 8 comprises, for example, a first securing element 8.1 formed on an inner circumference. The first securing element 8.1 is designed as a projecting pin or cam or pin. For this purpose, the base element 2 comprises counter-securing elements 2.3—in particular, a receptacle, a groove, or an opening, integrally formed (shown in FIG. 2).

Furthermore, the securing arrangement 8 comprises at least one second securing element 8.2 and/or a third securing element 8.3 on an outer circumference. The second securing element 8.2 can, for example, have several noses, pins, cams, or pins, at least two of which extend transversely. The transversely-extending second securing elements 8.2 are used for axial securing of the device 1. In other words, the second securing elements 8.2 secure the device 1 against an axial falling out of components. The third securing element 8.3 can have, for example, several noses, pins, cams, or pins, of which at least one or more extends perpendicularly. The third securing elements 8.3 extending perpendicularly act as an anti-rotation device of the device 1. In other words, the third securing elements 8.3 secure the device 1 against rotation of the components, and thus an undesired release or loosening of the components. In particular, through the third securing elements 8.3, the securing arrangement 8 and the base element 2 are arranged in a rotationally-fixed manner relative to each other.

Furthermore, a nut element 10 is provided as a counter-element to the screw element 8 in order to connect the two components B1, B2 to each other by a screw connection. The nut element 10 can be designed separately, as shown. Alternatively, the nut element 10 can be formed integrated and, for example, can be formed as an internal thread in the holding leg 6.1.2.

FIG. 2 shows the device 1 in a pre-assembly position 12 (described in more detail below) and in a position mounted on the component B1.

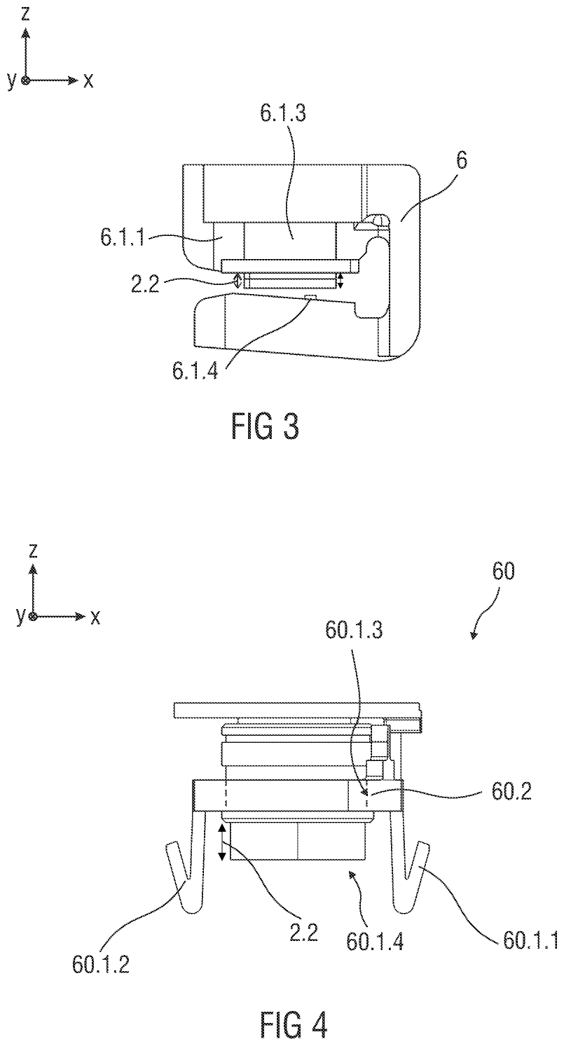

FIGS. 3 and 4 each show a schematic side view of the device 1 with integrated spacer portion 2.2 (for clarity, the base element 2 and the compensating element 3 are not shown in FIG. 3).

The spacer portion 2.2 extends axially downwards in the holding element 6 into the free space 6.1.4 of the holding element 6.

FIG. 3 shows a C-shaped holding element 6. The spacer portion 2.2 extends from the holding leg 6.1.1 into the free space 6.1.4.

FIG. 4 shows an alternative embodiment of a holding element 60. The holding portion 60.1 provided for fastening to the component B1 extends perpendicularly in the axial direction. Accordingly, the holding legs 60.1.1, 60.1.2 extend perpendicularly along the longitudinal center axis L. To accommodate the base element 2 with its spacer portion 2.2, a circumferential web 60.2—in particular, a holding ring—connecting the two perpendicular holding legs 60.1.1 and 60.1.2 is provided. The circumferential web 60.2 comprises a receptacle 60.1.3 for the base element 2, and in particular for its base portion 2.1.

The spacer portion 2.2 extends from the circumferential web 60.2 into a free space 60.1.4 between the two holding legs 60.1.1 and 60.1.2.

FIG. 5 shows a schematic side view of the one-piece base element 2 with its base portion 2.1 and its integrated spacer portion 2.2. In the upper region of the base portion 2.1, the counter-securing element 2.3 for transport securing is formed in the shape of a circumferential groove.

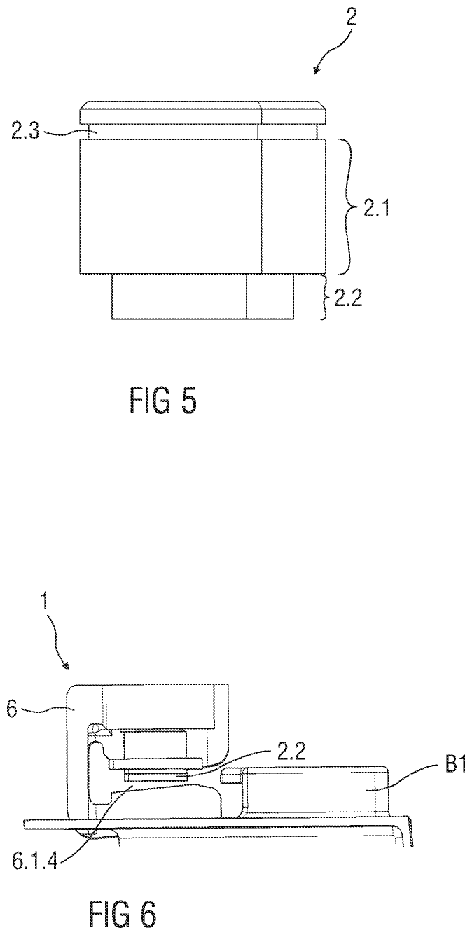

FIG. 6 shows a schematic side view of the device 1 in a pre-assembly position 12, without the compensating element 3 and with the base element 2 inserted, so that its spacer portion 2.2 projects into the free space 6.1.4.

This can lead to a collision between the component B1 and the spacer portion 2.2 in the free space 6.1.4 during assembly on the component B1.

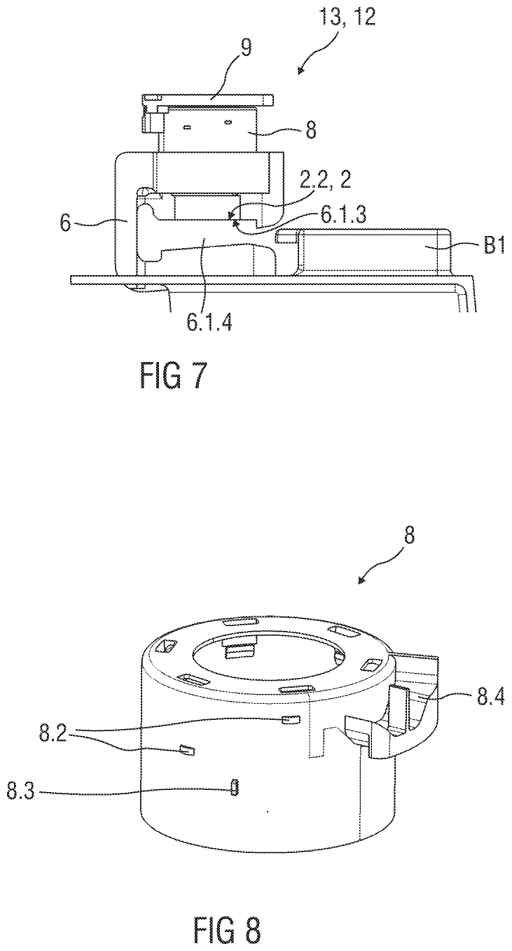

To avoid this, the base element 2 or a pre-assembly unit 13 formed at least from base element 2, compensating element 3, optional securing arrangement 8, and optional stop ring 9 is placed in a pre-assembly position 12 in which the spacer portion 2.2 is flush with the receptacle 6.1.3 of the holding element 6, as shown in FIG. 7. The free space 6.1.4 is thus free for inserting the component B1.

FIG. 7 is a schematic side view of the device 1 in the pre-assembly position 12 with spacer portion 2.2 arranged in the receptacle 6.1.3. In this pre-assembly position 12, the device 1 can be mounted on the component B1, or the component B1 on the device 1. FIG. 2 shows the device 1 in a pre-assembly position 12 and in a position mounted on the component B1.

FIG. 8 schematically shows a perspectival view of the securing arrangement 8 formed as a transport securing means. The securing arrangement 8 comprises, as outer securing elements 8.2 and 8.3, transversely—or perpendicularly-extending webs, pins, noses, or cams.

The second securing elements 8.2 are arranged axially and radially spaced apart from one another. The second securing elements 8.2 act as axial securing means and secure the components against an axial falling out or loosening relative to each other.

Of the third securing elements 8.3, only one perpendicularly-extending element is shown—in particular, a web, pin, nose, or cam. The securing arrangement 8 preferably comprises two third securing elements 8.3, which are distributed symmetrically, and in particular opposite one another, on the outer surface of the securing arrangement 8 and act as an anti-rotation means.

In addition, the securing arrangement 8 can comprise a fourth securing element 8.4, and in particular a stop securing means.

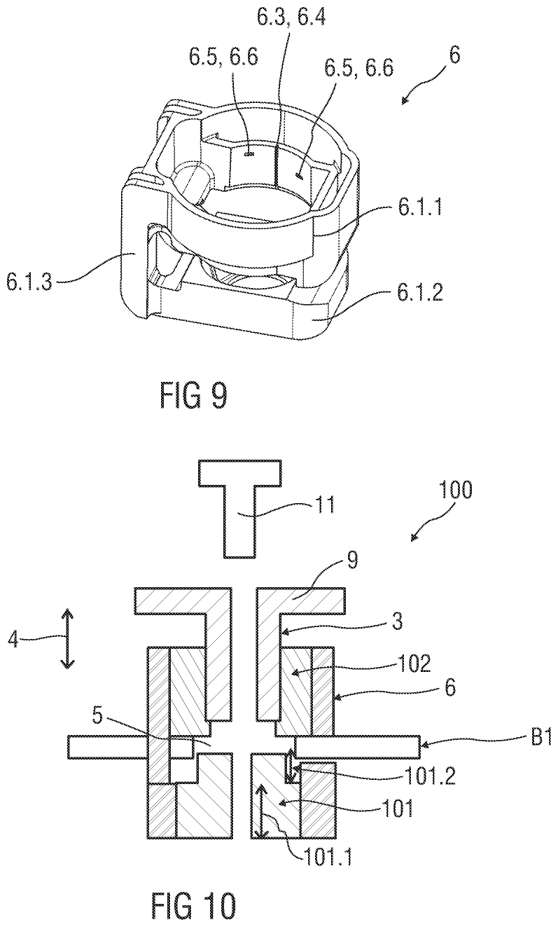

FIG. 9 schematically shows a perspectival view of the holding element 6, designed as a C-shaped clip and comprising, for example, the two holding legs 6.1.1 and 6.1.2, which are connected to one another via the web 6.2.

As a first counter-securing element 6.3, the holding element 6 comprises in particular a longitudinal groove 6.4, which acts as an anti-rotation means and is designed to receive the third securing element 8.3 of the securing arrangement 8. As a second counter-securing element 6.5, the holding element 6 comprises in particular a transverse web 6.6, which acts as axial securing means, and is designed to receive the second securing elements 8.2 of the securing arrangement 8.

FIG. 10 shows a schematic representation of an alternative embodiment of a device 100 for compensating for tolerances.

The device 100 comprises at least one base element 102, which has only one base portion 102.1, and the compensating element 3. The compensating element 3 is analogous to the base element 102. The compensating element 3 can be moved from an initial position into a compensation position according to arrow 4 by rotation relative to the base element 102.

The device 100 further comprises the screw element 11, passed through correspondingly provided openings 5 in the components B1, B2 and screwable into an alternative nut element 101, for screwing the components B1 and B2 together. Instead of the spacer portion 2.2 on the base element 2 according to the example shown in FIGS. 1 through 9, the nut element 101 is configured accordingly. For example, the nut element 101 has a base portion 101.1 and a spacer portion 101.2 which projects into the opening 5 of the component B1 in a state pre-positioned or fixed on one of the components B1. This spacer portion 101.2 is designed as a compression limiter in a manner analogous to the spacer portion 2.2 on the base element 2 of the previously described example according to FIGS. 1 through 9. To avoid repetition, reference is made to the previous description.

The holding element 6 is designed in an analogous manner to accommodate and hold the components of the device 100, such as the compensating element 3 with stop ring 9, the base element 102 and the nut element 101, and the component B1.

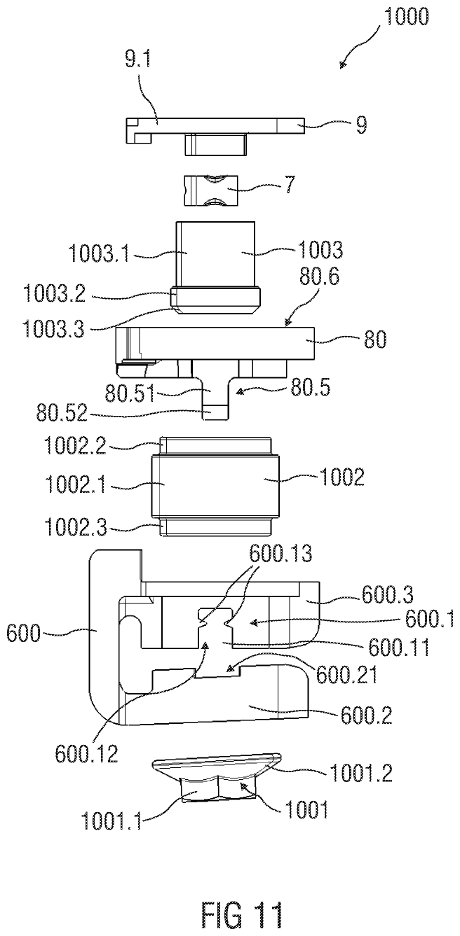

FIG. 11 schematically shows, in an exploded view, a further alternative embodiment of a device 1000 for compensating for tolerances. The device 1000 according to FIG. 11 differs from the devices 1 and 100 in each case in the form and structure of the base element 1002, the compensation element 1003, the holding element 600, and the securing arrangement 80.

The base element 1002 is formed as a hollow cylindrical base portion 1002.1 with an upper spacer portion 1002.2 and a lower spacer portion 1002.3.

The housing 1003 has a hollow cylindrical base portion 1003.1 and a second lower flange 1003.2. The flange 1003.2 is designed as a shoulder and has a chamfer 1003.3 at the lower end at the end face.

The securing arrangement 80 has a fifth securing element 80.5. The fifth securing element 80.5 can be designed as a perpendicularly—or axially-protruding securing arm 80.51, and in particular a latching arm with a latching hook 80.52.

The outer dimensions of the stop ring 9 are made corresponding to inner dimensions of a receptacle 80.6 of the securing arrangement 80, so that the stop flange 9.1 of the stop ring 9 can be arranged in the receptacle 80.6 in such a way that this stop flange 9.1 terminates flush with the end face of the securing arrangement 80.

The holding element 600 differs from the holding elements 6, 60 in that this holding element 600 has a third counter-securing element 600.1 for the fifth securing element 80.5. The third counter-securing element 600.1 is designed, for example, as a slot 600.11 with latching lips 600.13 protruding into a slot opening 600.12. In the assembled state, the latching hook 80.52 is held in a positive-fitting and/or non-positive-fitting manner on the latching lips 600.13.

The nut element 1001 can be designed, for example, as a countersunk nut and comprise a hexagonal portion 1001.1 and a countersunk portion 1001.2.

The holding element 600 comprises a correspondingly-shaped nut receptacle 600.21 in the region of a lower holding leg 600.2.

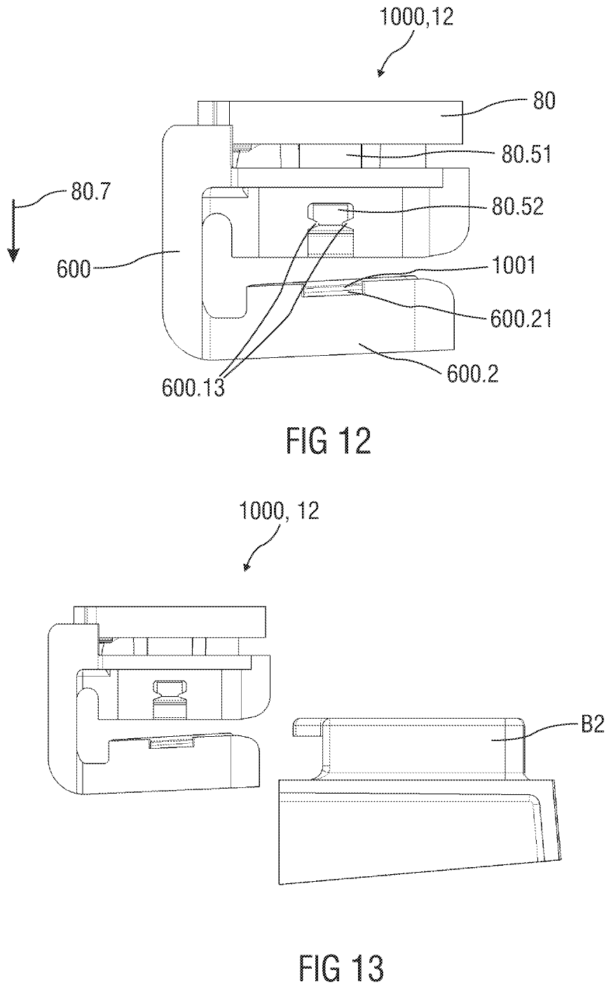

FIG. 12 shows a schematic side view of the pre-assembly position 12 of the device 1000 according to FIG. 11.

In the pre-assembly position 12, the nut element 1001 is pre-positioned and held in the nut receptacle 600.21 of the lower holding leg 600.2. Due to the hexagon section 1001.1, the nut element 1001 is arranged in a rotationally-fixed manner in the nut receptacle 600.21.

The stop ring 9 is arranged flush and not visible in the receptacle 80.6 of the securing arrangement 80.

The compensating element 1003, the base element 1002, and the driver 7 are set into one another in a manner analogous to that of the devices 1, 100 and can be held in the upper holding leg 600.3 by the securing arrangement 80 in a manner secure for transport. For this purpose, the compensating element 1003, the base element 1002, the driver 7, and the securing arrangement 80 are arranged coaxially to one another. In particular, these are set one inside the other and have corresponding through-openings 600.5.

The latching hooks 80.52 are still arranged above the latching lips 600.13 in the latching direction 80.7. These latching lips 600.13 ensure that the components (the compensating element 1003, the base element 1002, the driver 7, and the securing arrangement 80) of the device 1000 remain in position during a transport and cannot move axially.

FIG. 13 schematically shows an exploded view of the device 1000 according to FIG. 11 in the pre-assembly position 12, and one of the components B2.

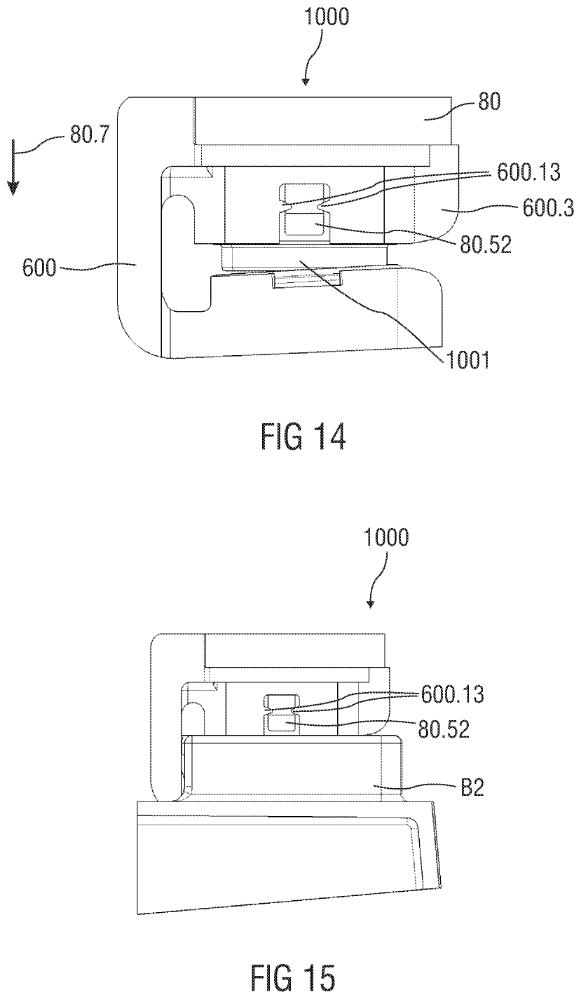

FIG. 14 shows a schematic side view of the device 1000 according to FIG. 11 with the securing arrangement 80 pressed in, so that the latching hooks 80.52 are arranged below the latching lips 600.13 in the latching direction 80.7. The device 1000 is balanced with regard to axial tolerances. The nut element 1001 is correspondingly tightened and abuts flat against the upper holding leg 600.3 of the holding element 600.

FIG. 15 shows a schematic side view of the device 1000 according to FIG. 11 in final position, in which the device 1000 is mounted on the component B2. The securing arrangement 80 as transport securing means remains in the device 1000 in the latched-in state, in which the latching hooks 80.52 act from below on the latching lips 600.13.

The holding legs 600.2 and 600.3 can each be designed as a hollow cylindrical element with corresponding through-openings 600.5. The walls of the hollow cylindrical elements can each be designed as a double wall or hollow wall. The lower through-opening 600.5 is designed as a nut receptacle 600.21 for the nut element 1001.

The holding legs 600.2, 600.3 themselves are flexible or deformable. The holding legs 600.2, 600.3 are connected to one another and arranged relative to one another via a web 600.6.

The respective holding leg 600.2, 600.3 has recesses 600.7 at the transition to the web 600.6, which serve for the deformation or flexibility of the holding legs 600.2, 600.3.

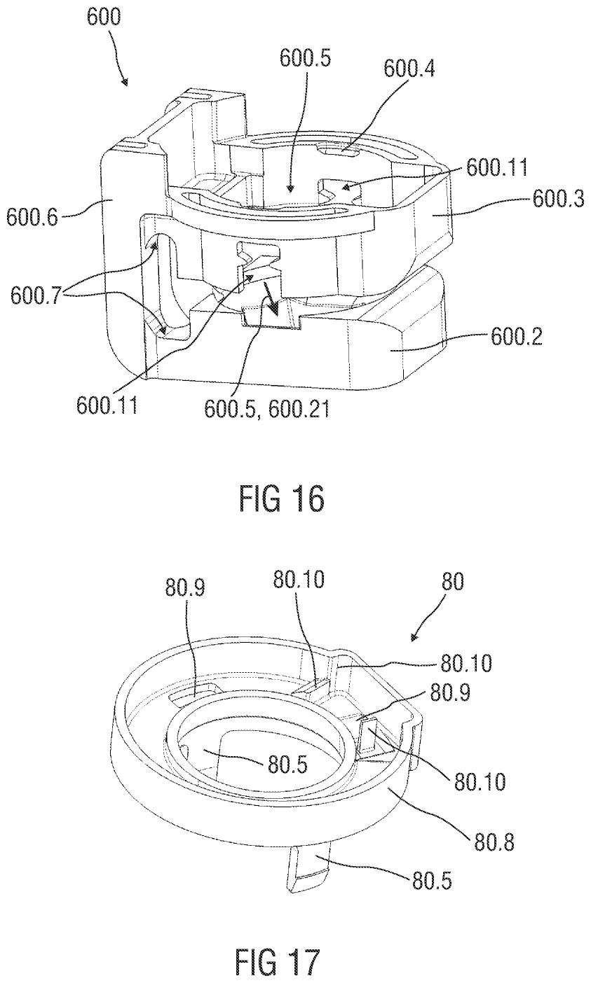

FIG. 16 is a schematic perspectival view of the holding element 600 of the device 1000 according to FIG. 11. In addition to the slots 600.11, the holding element 600 can comprise insertion recesses 600.4 (also referred to as insertion pockets) for the securing arrangement 80 designed as a transport securing means.

FIG. 17 schematically shows a perspectival view of the securing arrangement 80 designed as a transport securing means with the downwardly-projecting, fifth securing elements 80.5, which are designed as safety arms 80.51. At the upper end, the securing arrangement 80 has the receptacle 80.6 for the stop ring 9. For this purpose, the upper end is designed as a circumferential annular groove 80.8. The collar 9.1 (ring collar) can be arranged flush in the annular groove 80.8.

Further recesses 80.9 and/or stop elements 80.10, e.g., stop wedges, stop surfaces, stop noses, stop ramps, radial stop surfaces, or the like, can be provided in the annular groove 80.8 for the rotationally-fixed and transport-secure arrangement of the stop ring 9 in the securing arrangement 80.

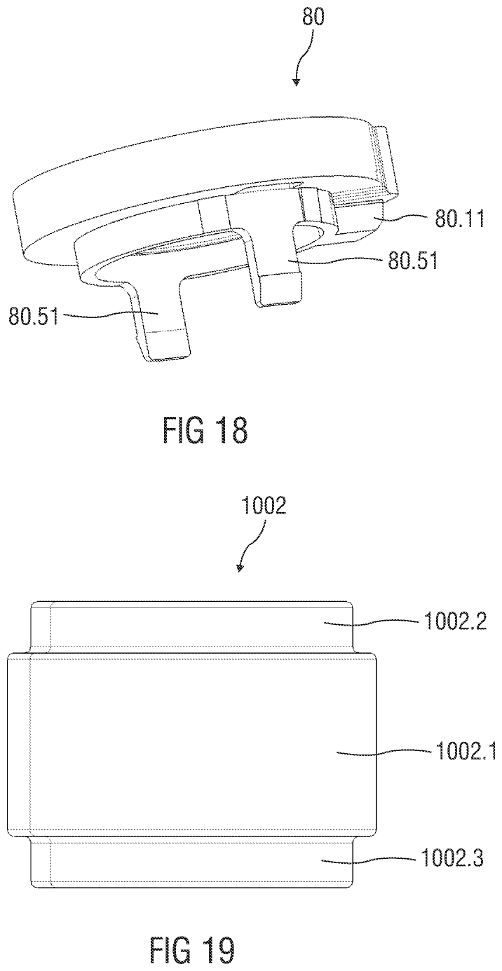

FIG. 18 schematically shows a further perspectival view of the securing arrangement 80 designed as a transport securing means from below with the axially-projecting securing arms 80. 51. In addition, the securing arrangement 80 can comprise a radial stop 80.11.

FIG. 19 schematically shows a perspectival view of the base element 1002 with its base portion 1002.1 and its spacer portions 1002.2, 1002.3 at its end faces.

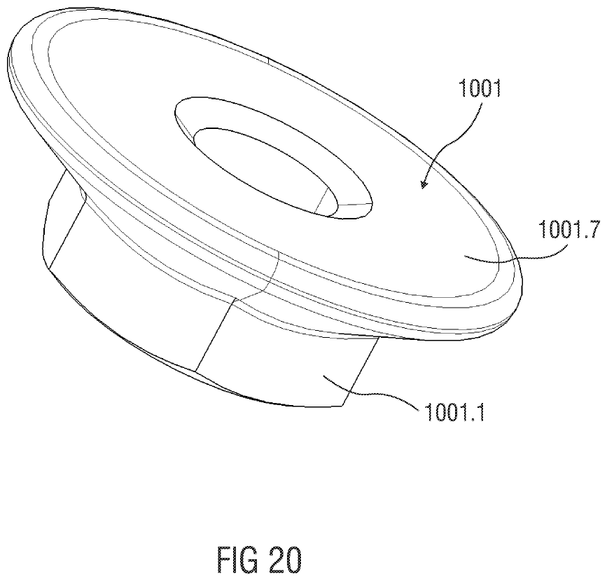

FIG. 20 schematically shows a perspectival view of the nut element 1001 with its hexagonal portion 1001.1 and its countersunk portion 1001.2.

### LIST OF REFERENCE SIGNS

1, 100, 1000 Device for compensating for tolerances
2, 102, 1002 Base element
2.1, 102.1, 1002.1 Base portion
2.2, 1002.2, 1002.3 Spacer portion
2.3 Counter-securing element
3, 1003 Compensating element
1003.1 Base portion
1003.2 Flange
1003.3 Chamfer
4 Arrow
5 Opening
6, 60, 600 Holding element
6.1, 60.1 Holding portion
6.1.1, 60.1.1 Holding legs
6.1.2, 60.1.2 Holding legs
6.1.3, 60.1.3 Receptacle
6.1.4, 60.1.4 Free space
6.2, 60.2 Web
6.3 First counter-securing element
6.4 Longitudinal groove
6.5 Second counter-securing element#
6.6 Transverse web
600.1 Third counter-securing element
600.11 Slot
600.12 Slot opening
600.13 Latching lip
600.2 Lower holding leg
600.21 Nut receptacle
600.3 Upper holding leg
600.4 Insertion recess
600.5 Through-opening
600.6 Web
600.7 Recess
7 Driving element
8, 80 Securing arrangement
8.1 First securing element
8.2 Second securing element
8.3 Third securing element
8.4 Fourth securing element
80.5 Fifth securing element
80.51 Securing arm
80.52 Latching hook
80.6 Receptacle
80.7 Latching direction
80.8 Annular groove
80.9 Recess
80.10 Stop element
80.11 Radial stop
9 Stop ring
9.1 Stop flange
9.2 Collar
10, 101, 1001 Nut element
1001.1 Hexagonal portion
1001.2 Countersunk portion
101.1 Base portion
101.2 Spacer portion
11 Screw element
12 Pre-assembly position
13 Pre-assembly unit

In the Claims:

1-10. (canceled)

11. A device for compensating for tolerances between two components to be connected to one another, wherein one of the components is formed from a creep-sensitive material, the device comprising:
a base element,
a compensating element which is in threaded engagement with the base element and which can be moved from a starting position into a compensating position by rotation relative to the base element,
wherein the base element is designed as a one-piece, hollow cylindrical element with a base portion and a spacer portion, and
wherein the spacer portion is pre-positioned or fixable on the component made of the creep-sensitive material such that this spacer portion projects into an opening of this component.

12. The device according to claim 11, wherein the spacer portion is configured to automatically tension the base element relative to the component.

13. A device for compensating for tolerances between two components to be connected to one another, wherein one of the components is formed from a creep-sensitive material, the device comprising:
a base element,
a compensating element which is in threaded engagement with the base element and which can be moved from a starting position into a compensating position by rotation relative to the base element, and
a screw element, which is guided through the device and through correspondingly provided openings in the components and can be screwed into a nut element for screwing the components,
wherein
the nut element has a base portion and a spacer portion, and
wherein the spacer portion is pre-positioned or fixable on the component made of the creep-sensitive material such that this spacer portion projects into an opening of this component.

14. The device according to claim 13, wherein the spacer portion is formed as an integrated portion on the base element or the nut element.

15. The device according to claim 13, wherein the spacer portion is designed as a compression limiter.

16. The device according to claim 15, wherein the compression limiter is axially aligned.

17. The device according to claim 13, wherein a securing arrangement is provided which is designed as a transport securing device and which holds the compensating element and the base element in a captive and movement-inhibiting manner or in a movement-resistant manner during transport.

18. The device according to claim 17, wherein the securing arrangement comprises a number of securing elements and a number of counter-securing elements which are arranged in cooperating fashion between the compensating element and the base element.

19. The device according to claim 17, wherein a stop ring is provided which is arranged between one of the components and the securing arrangement and/or the compensating element.

20. The device according to claim 19, wherein the stop ring is arranged in rotationally-fixed fashion on the compensating element and comprises a collar and a stop flange.
